(19) United States
(12) Patent Application Publication
(10) Pub. No.: US 2013/0107688 A1
(43) Pub. Date: May 2, 2013

(54) BACKPLANE WITH ENERGY SAVING FUNTION

(71) Applicant: WEI-DONG CONG, Shenzhen City (CN)

(72) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/325,565

(22) Filed: Dec. 14, 2011

(30) Foreign Application Priority Data
Oct. 31, 2011 (CN) 201110337354.1

(51) Int. Cl. G11B 27/36

(52) U.S. Cl. 369/53.1; G9B/27.052

(57) ABSTRACT

A backplane includes a reading module, a determination module, a control module, a light emitting diode (LED). When the backplane is in an energy saving state, the reading module reads a hard disk drive (HDD) state signal of a HDD. The determination module determines whether the read HDD state signal is the same as a predetermined HDD state signal to determine whether the HDD is normal. If the HDD is normal, the control module controls the LED to flicker according to a predetermined turn-on time and a predetermined turn-off time.

### 1. TECHNICAL FIELD

The present disclosure relates to backplanes, and particularly, to a backplane with energy saving function.

### 2. DESCRIPTION OF RELATED ART

In a server system, a backplane is used to connect hard disk drives (HDDs) to a motherboard. Two light emitting diodes (LEDs) are mounted on the backplane. One LED is used to indicate an operation state of the HDDs. The other LED is used to indicate whether the HDDs are normal. The LEDs have high brightness, which wastes energy.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present disclosure. Moreover, in the drawings, all the views are schematic, and like reference numerals designate corresponding parts throughout the several views.

FIG. 1 is a block diagram of an exemplary embodiment of a backplane connected to a hard disk drive, a motherboard, and a power supply, wherein the backplane includes a jumper, a main controller, and a power interface.

FIG. 2 is a block diagram of the jumper connected to the power supply, the main controller, and the power interface connected to the power supply of FIG. 1.

FIG. 3 is a block diagram of the main controller of FIG. 1.

FIGS. 4 and 5 are flowcharts of an exemplary embodiment of a method for saving energy.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

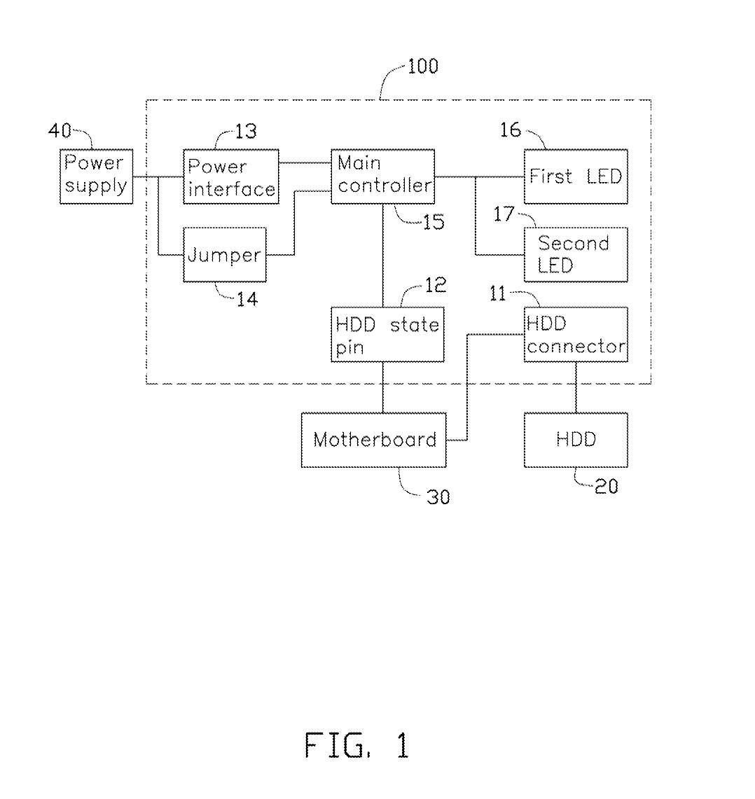

Referring to the FIG. 1, an embodiment of a backplane 100 with energy saving function includes a hard disk drive (HDD) connector 11, an HDD state pin 12, a power interface 13, a jumper 14, a main controller 15, a first light emitting diode (LED) 16, and a second LED 17. The HDD connector 11 is connected to a motherboard 30. When an HDD 20 is connected to the HDD connector 11, the HDD 20 can communicate with the motherboard 30.

The power interface 13 is connected to a power supply 40 to receive a voltage. The power interface 13 is also connected to the main controller 15 to output the voltage to the main controller 15.

The HDD state pin 12 is connected to the motherboard 30 to receive an HDD state signal corresponding to the HDD 20 from the motherboard 30.

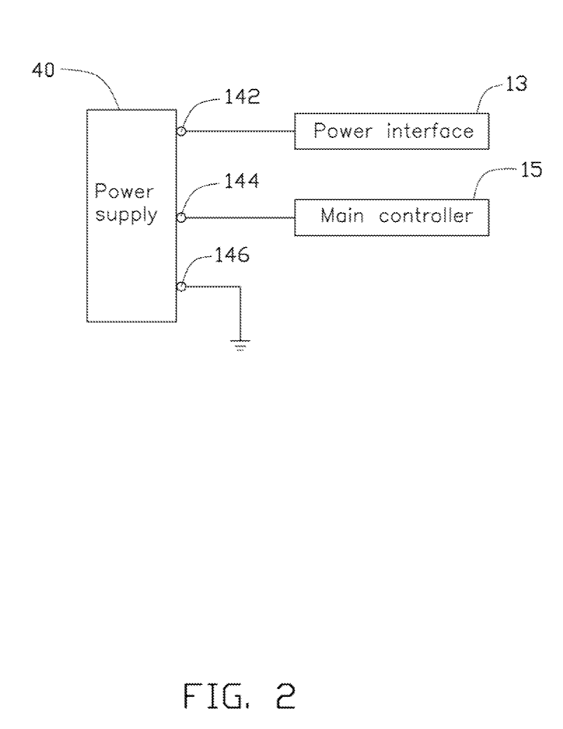

Referring to FIG. 2, the jumper 14 includes a first pin 142, a second pin 144, and a third pin 146. The first pin 142 is connected to the power interface 13 to receive the voltage. The second pin 144 is connected to the main controller 15. The third pin 146 is grounded. The main controller 15 is also connected to the first and second LEDs 16 and 17.

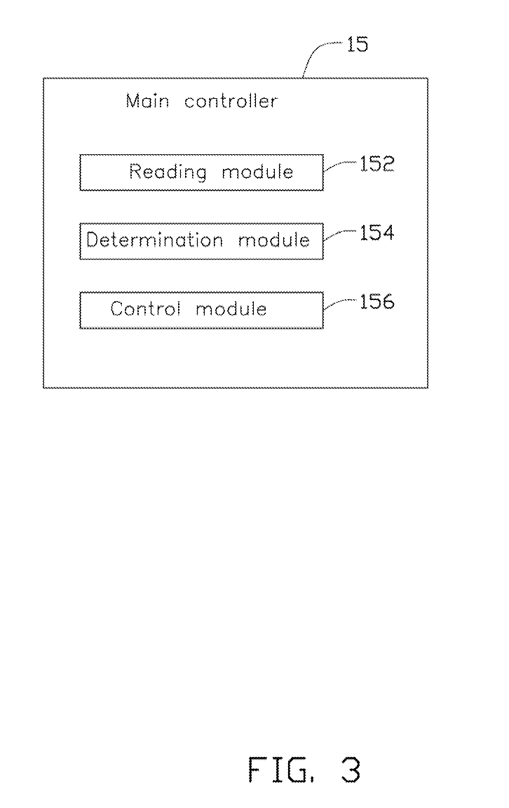

Referring to FIG. 3, the main controller 15 includes a reading module 152, a determination module 154, and a control module 156.

The reading module 152 reads the HDD state signal from the HDD state pin 12.

The determination module 154 determines whether the read HDD state signal is the same as a predetermined HDD state signal to determine whether the HDD 20 is normal. If the read HDD state signal is different from the predetermined HDD state signal, it denotes that the HDD 20 is abnormal. The determination module 154 outputs a first control signal to the control module 156. If the read HDD state signal is the same as the predetermined HDD state signal, it denotes that the HDD is normal. The determination module 154 outputs a read signal to the reading module 152.

The reading module 152 reads a level signal output by the second pin 144 of the jumper 14 after receiving the read signal. In the embodiment, when the backplane 100 is set to be in an energy saving state, the first pin 142 is connected to the second pin 144 of the jumper 14 through a jump cap. At that time, the level signal output by the second pin 144 is a logic 1 high level signal. When the backplane 100 is set to be in non-energy saving state, the second pin 144 is connected to the third pin 146 of the jumper 14 through the jumper cap. At that time, the level signal output by the second pin 144 is a logic 0 low level signal.

The determination module 154 determines whether the read level signal is the same as a predetermined level signal such as the high level signal. If the read level signal is the same as the predetermined level signal, the determination module 154 outputs a second control signal to the control module 156. If the read level signal is different from the predetermined level signal, the determination module 154 outputs a third control signal to the control module 156.

The control module 156 turns on the second LED 17 after receiving the first control signal to denote that the HDD 20 is abnormal. The control module 156 turns on the first LED 16 after receiving the second control signal, and times for the turned on first LED 16.

The determination module 154 detects a turn-on time timed by the control module 156, and determines whether the timed turn-on time reaches a first predetermined time. If the turn-on time reaches the first predetermined time, the determination module 154 outputs a fourth control signal to the control module 156. If the turn-on time does not reach the first predetermined time, the determination module 154 continues to detect the turn-on time timed by the control module 156.

The control module 156 turns off the first LED 16 after receiving the fourth control signal, and times for the turned off first LED 16.

The determination module 154 detects a turn-off time timed by the control module 156, and determines whether the timed turn-off time reaches a second predetermined time. If the turn-off time reaches the second predetermined time, the determination module 154 outputs the second control signal to the control module 156 to turn on the LED 16 again. If the turn-off time does not reach the second predetermined time, the determination module 154 continues to detect the turn-off time timed by the control module 156. Therefore, when the backplane 100 is in the energy saving state, the control module 156 controls the first LED 16 to flicker according to the first and second predetermined time, thereby avoiding the first LED 16 to turn on all the time, thus saving energy.

The control module 156 turns on the first LED 16 after receiving the third control signal.

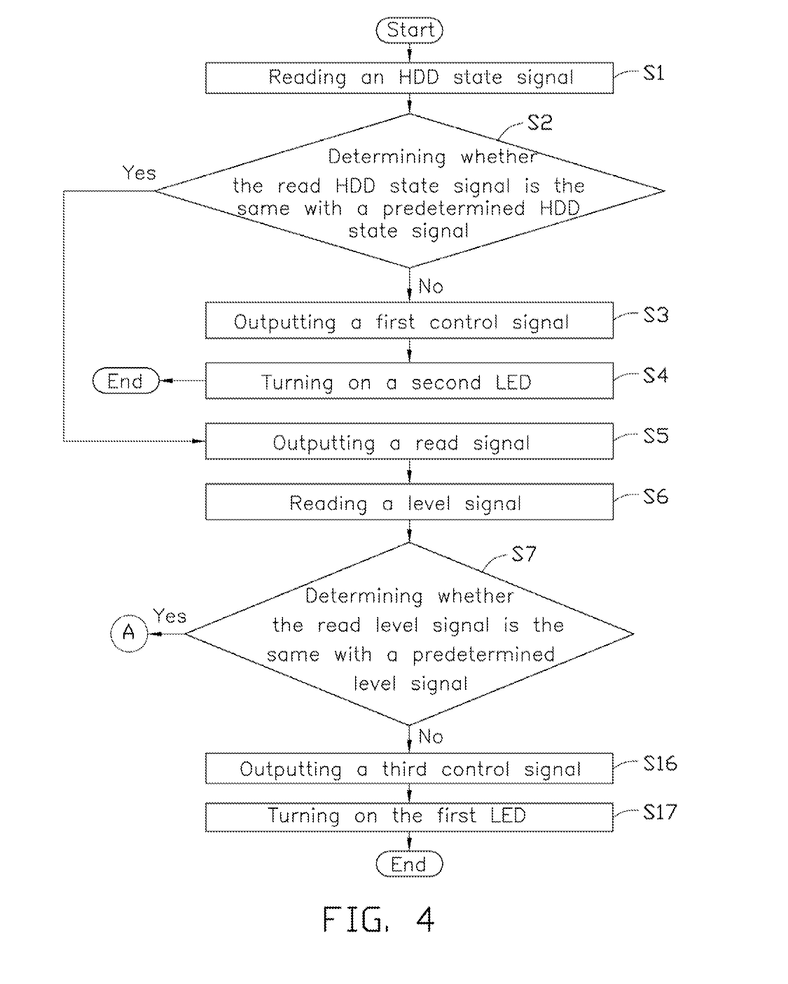

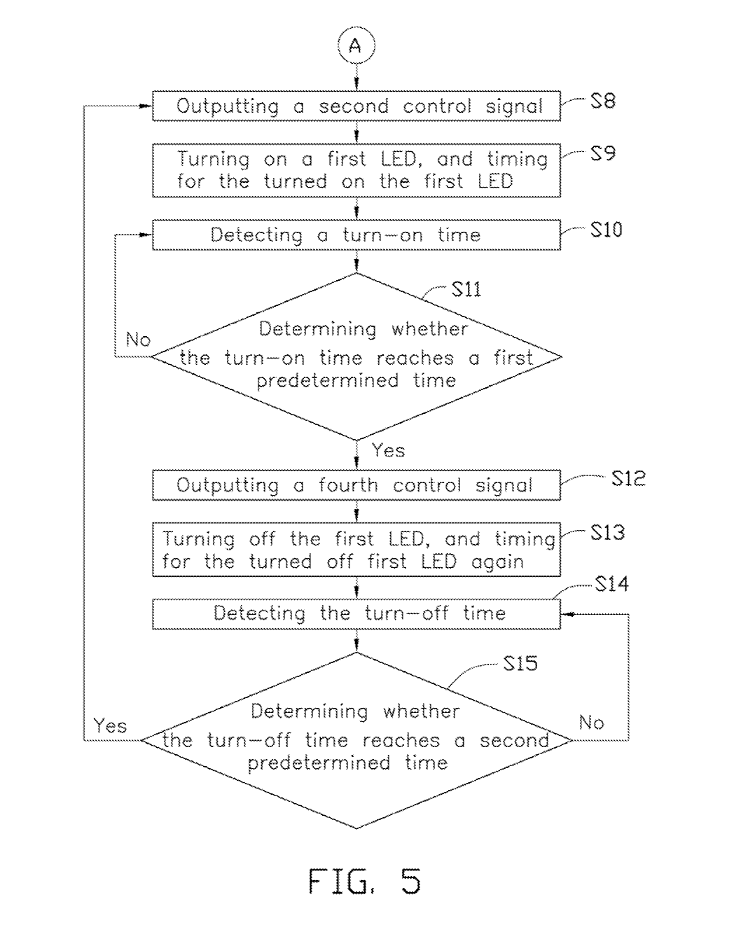

Referring to FIGS. 4 and 5, an exemplary embodiment of a method for saving power includes the following steps.

In step 1, the reading module 152 reads the HDD state signal from the HDD state pin 12.

In step 2, the determination module 154 determines whether the read HDD state signal is the same as the stored predetermined HDD state signal. If the read HDD state signal is different from the stored predetermined HDD state signal, it denotes that the HDD 20 is abnormal, the procedure goes to step S3. If the read HDD state signal is the same as the stored predetermined HDD state signal, it denotes that the HDD 20 is normal, the procedure goes to step S5.

In step 3, the determination module 154 outputs the first control signal to the control module 156.

In step 4, the control module 156 turns on the second LED 17 to denote that the HDD 20 is abnormal.

In step 5, the determination module 154 outputs the read signal to the reading module 152.

In step 6, the reading module 152 reads the level signal outputted by the second pin 144 of the jumper 14.

In step 7, the determination module 154 determines whether the read level signal is the same as the predetermined level signal. If the read level signal is the same as the predetermined level signal, the procedure goes to step S8. If the read level signal is different from the predetermined level signal, the procedure goes to step S16.

In step 8, the determination module 154 outputs the second control signal to the control module 156.

In step 9, the control module 156 turns on the first LED 16, and times for the turned on first LED 16.

In step 10, the determination module 154 detects the turn-on time timed by the control module 156.

In step 11, the determination module 154 determines whether the timed turn-on time reaches the first predetermined time. If the turn-on time reaches the first predetermined time, the procedure goes to step S12. If the turn-on time does not reach the first predetermined time, the procedure goes back to step S10.

In step 12, the determination module 154 outputs the fourth control signal to the control module 156.

In step 13, the control module 156 turns off the first LED 16 after receiving the fourth control signal, and times for the turned off first LED 16.

In step 14, the determination module 154 detects the turn-off time timed by the control module 156.

In step 15, the determination module 154 determines whether the timed turn-off time reaches the second predetermined time. If the turn-off time reaches the second predetermined time, the procedure goes back to step S8. If the turn-off time does not reach the second predetermined time, the procedure goes back to step S14.

In step 16, the determination module 154 outputs the third control signal to the control module 156.

In step 17, the control module 156 turns on the first LED 16 after receiving the third control signal.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A backplane, comprising:
a hard disk drive (HDD) connector to connect an HDD, thereby connecting the HDD to a motherboard;
a power interface connected to a power supply to receive a voltage from the power supply;
a HDD state pin connected to the motherboard to receive an HDD state signal corresponding to the HDD from the motherboard;
a jumper to output a level signal;
a first light emitting diode (LED); and
a main controller connected to the power interface to receive the voltage, connected to the HDD state pin, connected to the jumper to receive the level signal, and connected to the first LED, the main controller comprising:
a reading module to read the HDD state signal from the HDD state pin;
a determination module to determine whether the read HDD state signal is the same as a predetermined HDD state signal, wherein if the read HDD state signal is the same as predetermined HDD state signal, the determination module outputs a read signal to the reading module, the reading module reads the level signal from the jumper after receiving the read signal, the determination module determines whether the read level signal is the same as a predetermined level signal, if the read level signal is the same as the predetermined level signal, the determination module outputs a first control signal, if the read level signal is different from the predetermined level signal, the determination module outputs a second control signal; and
a control module to control the first LED to flicker according to a predetermined turn-on time and a predetermined turn-off time after receiving the first control signal, and turns on the first LED after receiving the second control signal.

2. The backplane of claim 1, wherein when the control module receives the first control signal, the control module times for the first LED, the determination module detects the turn-on time timed by the control module, and determines whether the turn-on time reaches the predetermined turn-on time, if the turn-on time reaches the predetermined turn-on time, the determination module outputs a third control signal to the control module, if the turn-on time does not reach the predetermined turn-on time, the determination module continues to detect the turn-on time timed by the control module, the control module turns off the first LED after receiving the third control signal, and times for the turned off first LED, the determination module further determines whether the turn-off time reaches the predetermined turn-off time, if the turn-off time reaches the predetermined turn-off time, the determination module outputs the first control signal to the control module, if the turn-off time does not reach the predetermined turn-off time, the determination module continues to detect the turn-off time timed by the control module.

3. The backplane of claim 1, wherein the jumper includes a first pin, a second pin, and a third pin, the first pin is connected to the power supply to receive the voltage, the second pin is connected to the main controller, the third pin is grounded, the second pin is connected to either the first pin or the third pin, to output the corresponding level signal.

4. The backplane of claim 3, wherein the predetermined level signal is a high level signal, when the first pin is connected to the second pin, the second pin outputs a high level signal, when the second pin is connected to the third pin, the second pin outputs a low level signal.

5. The backplane of claim 1, further comprising a second LED connected to the main controller, wherein when the determination module determines that the read HDD state signal is different from the predetermine HDD state signal, the determination module outputs a fourth control signal to the control module, the control module turns on the second LED after receiving the fourth control signal.

6. A method for saving energy for a backplane connected between a motherboard and a hard disk drive (HDD), the method comprising:
reading a HDD state signal corresponding to the HDD from the motherboard;
determining whether the read HDD state signal is the same as a predetermined HDD state signal;
outputting a read signal if the read HDD state signal is the same as the predetermined HDD state signal;
reading a level signal from a jumper after receiving the read signal;
determining whether the read level signal is the same as a predetermined level signal;
outputting a first control signal if the read level signal is the same as the predetermined level signal;
controlling a first light emitting diode (LED) to flicker according to a predetermined turn-on time and a predetermined turn-off time after receiving the first control signal;
outputting a second control signal if the read level signal is different from the predetermined level signal; and
turning on the first LED after receiving the second control signal.

7. The method of claim 6, wherein the step of controlling a first LED to flicker according to a predetermined turn-on time and a predetermined turn-off time after receiving the first control signal is realized through the following steps:
turning on the first LED after receiving the first control signal, and timing for the first LED;
detecting a timed turn-on time of the first LED;
determining whether the timed turn-on time reaches the predetermined turn-on time;
if the timed turn-on time does not reach the predetermined turn-on time, the procedure goes back to the step of detecting a timed turn-on time;
outputting a third control signal if the timed turn-on time reaches the predetermined turn-on time;
turning off the first LED after receiving the third control signal, and timing for the turned off first LED;
detecting a timed turn-off time of the first LED; and
determining whether the timed turn-off time reaches the predetermined turn-off time, if the timed turn-off time reaches the predetermined turn-off time, the procedure goes back to the step of outputting a first control signal, if the timed turn-off time does not reach the predetermined turn-off time, the procedure goes back to the step of detecting a timed turn-off time of the first LED.

8. The method of claim 6, after the step of determining whether the read HDD state signal is the same as a predetermined HDD state signal, the method comprising:
outputting a fourth control signal if the read HDD state signal is different from the predetermined HDD state signal; and
turning on a second LED after receiving the fourth control signal.

9. The method of claim 8, wherein the predetermined level signal is a high level signal, when the first pin is connected to the second pin, the second pin outputs a high level signal, when the second pin is connected the third pin, the second pin outputs a low level signal.
